(19) United States
(12) Patent Application Publication
(10) Pub. No.: US 2011/0082240 A1
(43) Pub. Date: Apr. 7, 2011

(54) ROSIN OIL-MODIFIED BITUMEN AND THE BITUMINOUS COMPOSITION CONTAINING THEREOF

(75) Inventor: Everett Crews, Charleston, SC (US)

(73) Assignee: Meadwestvaco Corporation, Raleigh, NC (US)

(21) Appl. No.: 12/990,911

(22) PCT Filed: Apr. 28, 2009
(86) PCT No.: PCT/US09/41966

§ 371 Date: Dec. 7, 2010

Related U.S. Application Data
(60) Provisional application No. 61/050,287, filed on May 5, 2008.

(51) Int. Cl. C09D 193/04

(52) U.S. Cl. 524/69; 106/232; 524/59; 524/71

(57) ABSTRACT

A rosin oil-modified bitumen compound having a significantly reduced viscosity compared to the conventional bitumen at same temperature, yet providing the bituminous composition of comparable indirect tensile strength and performance is disclosed. The bituminous composition made of the disclosed modified bitumen allows the production and application at lower temperatures than the conventional bituminous composition, and thereby a reduction in energy consumption and a lower emission level of organic volatiles and fumes.

This non-provisional application relies on the filing date of provisional U.S. Application Ser. No. 61/050287 filed on May 5, 2008, which is incorporated herein by reference, having been filed within twelve (12) months thereof, and priority thereto is claimed under 35 USC §119(e).

### BACKGROUND OF THE DISCLOSURE

Hot mix bituminous composition, typically referred to by those skilled in the art as hot-mix asphalt (HMA), has been widely used for paving application. It consists principally of aggregate and bitumen binder generally made by mixing pretreated aggregate and bitumen binder in either batch or continuous mixing equipment. HMA paving composition requires high production and application temperatures.

Prior to mixing, the aggregate is heated to temperatures exceeding 150° C. to quantitatively remove both surface and pore-bound moisture. Bitumen is heated to temperatures typically exceeding 143° C. to lower the viscosity of the product and make it suitable for pumping through conventional liquid transfer equipment. The resulting paving composition typically has a temperature exceeding 143° C. upon exiting the mixing equipment to ensure that it can be discharged uniformly from haul trucks; processed easily through asphalt paver equipment; and compacted to desired densities under compressive force of conventional, static, vibratory, or oscillatory steel and pneumatic compacting equipment.

HMA paving composition must be laid down and compacted at the temperature in excess of 150° C., since its compactability depends on the temperature. The handling, placement and compaction of composition become extremely difficult and the design densities (air voids) cannot be achieved, if a temperature of the hot mix paving composition is below 100° C. Failure to reach the design densities results in deformation or rutting of the pavement layer in the wheel paths of vehicular traffic. Additionally, failure to reach design density may yield an overly porous pavement susceptible to moisture intrusion and moisture-related distress.

To address the processing difficulty due to high viscosity, paving grade bitumen is typically pre-diluted with bitumen-compatible solvents such as diesel, naphtha, gasoline, kerosene, biodiesel, waste oils, and other suitable bitumen-compatible diluents. For example, U.S. Pat. No. 4,085,078 discloses a method of reducing the viscosity of rubber-modified bitumen using a diluent selected from a group consisting of petroleum fraction distilled from crude oil at a temperature of from about 174° C. to about 325° C. It is reported that when the diluent is admixed with the rubber or bitumen prior to the formation of rubber-modified bitumen, the viscosity of the resulting rubber-modified bitumen product is reduced to at lest one half as compared to the viscosity of the rubber-modified bitumen having the diluent admixed after the formation thereof.

Pre-dilution of the bitumen reduces the required temperature of the bitumen phase during the production of the bituminous emulsion, as well as prevents a potential boil out of the finished product. However, use of bitumen-compatible solvents or other diluents has undesirable consequences. Fugitive vapors in the solvent pose health hazards for worker and concerns for air pollutants due to the volatile emission. The solvent may leach into soils and groundwater supplies, deteriorating water and soil quality. Moreover, the solvent residue may remain in the bitumen of the finished pavement structure, causing a significant reduction in stiffness of the pavement. Reduction in stiffness, in turn, leads to deformation in the pavement structure under a load of traffic. Thus, application of such paving composition containing residue solvent is primarily limited to highways for rural and/or low traffic volume routes.

Accordingly, there has been an increasing need for bituminous paving composition that can be produced, transferred and applied at a lower temperature range than the typically high temperature required for hot-mix paving composition, while maintaining the paving performance of the hot-mix paving composition.

### SUMMARY OF THE DISCLOSURE

A rosin oil-modified bitumen compound having a significantly reduced viscosity compared to the conventional bitumen at same temperature, yet providing the bituminous composition of comparable indirect tensile strength and performance, is disclosed. The bituminous composition made of the disclosed modified bitumen compound allows the production and application at lower temperatures than the conventional bituminous composition, and thereby a reduction in energy consumption and a lower emission level of organic volatiles and fumes.

### BRIEF DESCRIPTION OF THE DRAWINGS

FIG. 1 is a graph showing Brookfield viscosity at 135° C. of the disclosed rosin oil-modified bitumen compound, wherein the bitumen component was modified with rosin oil at different levels: 0, 1, 2, and 4 parts of rosin oil per 100 parts of bitumen component; and

FIG. 2 is a graph showing the comparative Brookfield viscosities (in log) of the control bitumen, the rosin resin-modified bitumen, and rosin oil-modified bitumen at different temperatures.

### DETAILED DESCRIPTION OF THE DISCLOSURE

The present disclosure now will be described more fully hereinafter, but not all embodiments of the disclosure are necessarily shown. While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope

The terms “bitumen” or “bituminous” in the present disclosure refer to naturally-occurring bitumen and modified bitumen. They are also known as “asphalt.”

The rosin oil-modified bitumen compound of the present disclosure includes:

(a) bitumen component; and

(b) rosin oil, wherein an amount of the rosin oil is from about 0.01 to about 25 parts per 100 parts of the bitumen.

Bitumen Component

Suitable bitumen component for use in the present disclosure may be bitumen, polymer-modified bitumen, and combinations thereof. The bitumen component may be those which exhibit rheological properties that are appropriate for paving applications under specific climatic conditions, such as those which conform to the Strategic Highway Research Program (SHRP) pavement binder specifications. Furthermore, the bitumen component may conform to specifications of viscosity-graded and/or penetration-graded bitumen.

Examples of such bitumen component may include, but are not limited to, naturally occurring bitumen; polymer-modified bitumen, bitumen derived from crude oil; petroleum pitches obtained from a cracking process; coal tar; recycled crumb rubber from recycled tires, and combinations thereof.

The polymer-modified bitumen may be produced by modifying the bitumen with polymer such as natural rubbers, synthetic rubbers, plastomers, thermoplastic resins, thermosetting resins, elastomers, and combinations thereof. Examples of such polymers include, but are not limited to, styrene-butadiene-styrene (SBS), styrene-butadiene-rubber (SBR), polyisoprene, polybutylene, butadiene-styrene rubber, vinyl polymer, ethylene vinyl acetate, ethylene vinyl acetate derivative and the like.

Rosin Oil

Rosin oil is a nearly neutral chemical compound obtained from decarboxylation of rosin resins in the presence or absence of catalyst. Various rosin resins may be used as sources of the rosin oils in the present disclosure. These include, but are not limited to, tall oil rosin, gum rosin, wood rosin, and mixtures thereof. Rosin resin consists mainly of abietic acid; therefore, its decarboxylation is rather sluggish without catalyst. However, in the presence of catalysts such as zinc, sulfonic acids and siliceous earths, the decarboxylation of the rosin resins takes place readily at temperatures range of about 120° C. to about 280° C.

The bituminous composition of the present disclosure includes:

(i) a rosin oil-modified bitumen compound, comprising:
(a) bitumen component, and
(b) rosin oil, wherein an amount of the rosin oil is from about 0.01 to about 25 parts per 100 parts of the bitumen component in (a); and

(ii) aggregate.

Any aggregate used in paving materials and road construction, road rehabilitation, road repair and road maintenance derived from natural or synthetic sources may be used in the present disclosure. These include, but are not limited to, dense-graded aggregate, gap-graded aggregate, open-graded aggregate, stone-matrix asphalt, reclaimed asphalt pavement, reclaimed roofing shingles and mixtures thereof.

Where desired, the bituminous compositions of the present disclosure may further include additives to enhance the processability and paving performance. Examples of such additives include, but are not limited to, surfactants; mineral additives such as lime and cement; and fibrous additives such as cellulose, glass and polymer fibers. Additionally, reclaimed asphalt pavement material may be used as additive.

The bituminous compositions of the present disclosure may be used as paving compositions for load-bearing pavement and/or high traffic pavements.

The rosin oil-modified bitumen compound of the present disclosure has a lower viscosity compared to the conventional bitumen at same temperature, yet providing the bituminous paving composition with comparable indirect tensile strength and superpave binder characteristics. As a result, the disclosed rosin oil-modified bitumen may be used in the production of bituminous composition that is suitable for paving applications at a lower temperature than that of the conventional hot-mix bituminous paving compositions, while maintaining the desired hot-mix paving performances.

The rosin oil-modified bitumen compound of the present disclosure may be used for the production of any known warm-mix bituminous compositions or hot-mix bituminous composition.

Additionally, the disclosed rosin oil-modified bitumen compound may be used as an adhesive promoters for hot-mix asphalt concrete, cold mix asphalt applications, and the maintenance applications of chip seal, slurry seal, and micro-surfacing. Additionally, the disclosed modified asphalt may facilitate low-temperature compactization in the dry process of rubberized asphalt concrete production, wherein the homogenization of the dry rubber crumbs with liquid asphalt and aggregate typically requires an elevated temperature that resulting in undesirable fuming and odor generation.

The following example is provided to further illustrate the present disclosure and is not to be construed as limiting the disclosure in any manner.

### EXAMPLES

Viscosity Study

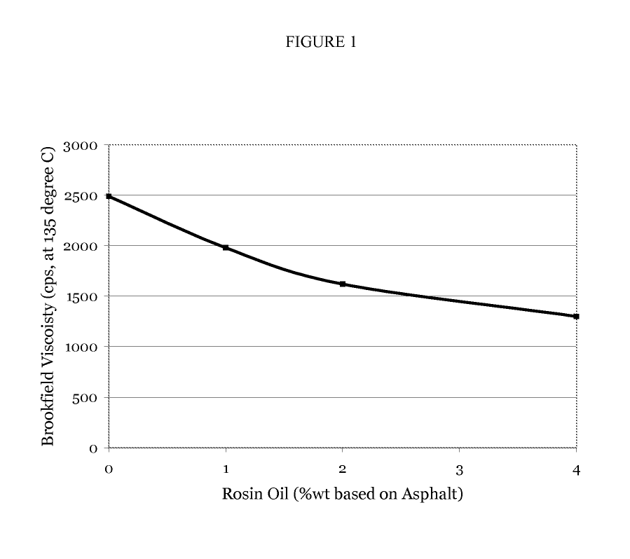

Rosin oil was reacted with a polymer-modified bitumen PG 76-22 at 130° C. The resulting modified asphalt was stored at 80° C. for 24 hours, and then its Brookfield viscosity at 130° C. was determined. Different ratio of the rosin oil to polymer-modified asphalt was investigated. (TABLE 1, FIG. 1) When about 4 parts of the rosin oil was reacted with about 100 parts of the asphalt, the resulting modified asphalt showed a significantly reduced viscosity (1,300 cps) compared to the asphalt unmodified with rosin oil (2,490 cps).

TABLE 1

| Modified | Parts of Rosin Oil | Brookfield | % Change in |
|---|---|---|---|
| Asphalt | per 100 parts of | Viscosity | the Viscosity |
| No. | Asphalt | (cps) | (Compared to Control) |
| A | 0 | 2490 | — |
| (Control) | | | |
| B | 1 | 1980 | 20% |
| C | 2 | 1620 | 35% |
| D | 4 | 1300 | 48% |

Additionally, the viscosity of the rosin oil-modified bitumen was compared to that of the rosin resin-modified bitumen. The rosin oil-modified bitumen was prepared by reacting the bitumen PG 76-22 with rosin oil at a weight ratio of 2.32 part rosin oil/100 part of bitumen PG 76-22. The rosin resin-modified bitumen was prepared by reacting the bitumen PG 76-22 with tall oil rosin resin at a weight ratio of 2.32 part rosin resin/100 part of bitumen PG 76-22. The Brookfield viscosity of the resulting modified bitumen were measured at several temperatures and compared to that of the control bitumen PG 76-22.

TABLE 2

| | Brookfield Viscosity (cP) | | |
|---|---|---|---|
| | Temp = | Temp = | Temp = |
| Sample | 150° C. | 160° C. | 170° C. |
| Bitumen PG 76-22 | 850 | 560 | 385 |
| (Control) | | | |
| Rosin Resin- | 980 | 600 | 414 |
| modified Bitumen | | | |
| Rosin Oil- | 697 | 466 | 320 |
| Modified Bitumen | | | |

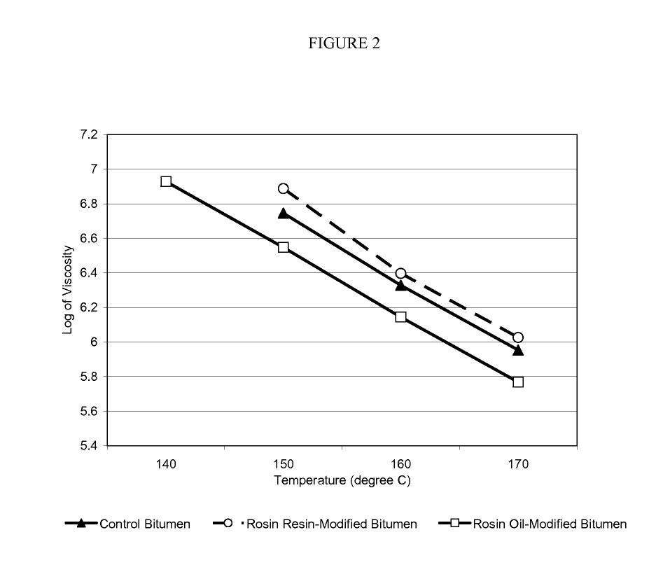

As shown in TABLE 2 and FIG. 2, the rosin oil-modified bitumen shows a significantly lower viscosity compared to the control. In contrast, the rosin resin-modified bitumen shows an increase in the viscosity compared to the control.

Indirect Tensile Strength Study

About 59.4 g of the resulting rosin oil-modified asphalt was mixed with about 1100 g of NCAT granite aggregates at about 150° C. to produce a bituminous composition. The rosin oil-modified asphalt showed an enhanced coating to the aggregates, compared to the asphalt unmodified with rosin oil. The higher the level of rosin oil modification, the faster the full coating of aggregate was achieved.

After being conditioned for 2 hours, the bituminous composition was compacted on the gyrator compactor at 130° C. into a pill with a height of 63.5 mm. After being stored overnight at 25° C., the pill was measured for tensile strength. As shown in TABLE 3, the bituminous composition made of the rosin oil-modified asphalt had about the same indirect tensile strength as the bituminous composition made of the asphalt unmodified with rosin oil.

TABLE 3

| Bituminous Com- | | | | |
|---|---|---|---|---|
| position from | Pill (g) | | Indirect | Indirect |
| Modified Bitumen | at | Caliper | Tensile | Tensile |
| No. | Break | (mm) | (lbs_{f}) | (psi) |
| A | 1087.1 | 63.4 | 2280 | 148 |
| B | 1091.8 | 63.3 | 2320 | 151 |
| C | 1088.7 | 63.4 | 2220 | 144 |
| D | 1089.0 | 63.4 | 2425 | 157 |

Superpave Binder Testing

The polymer-modified bitumen PG 76-22 was reacted with rosin oil using the aforementioned procedure, at two different levels of the rosin oil: 1.5% and 3.0% by weight of the rosin oil to the bitumen. The resulting rosin oil-modified samples were subjected to the Superpave binder testing to determine their true binder grading by Paragon Technical Services.

TABLE 4

| Sample | I (Control) | II | III |
|---|---|---|---|
| Rosin Oil (% by wt. | 0 | 1.5 | 3.0 |
| of PG76-22) | | | |
| G*/sinδ = 1.0 kPa | 80.9 | 77.4 | 76.0 |
| G*/sinδ = 2.2 kPa | 81.6 | 80.6 | 78.2 |
| G* sinδ = 5.0 MPa | 18.5 | 19.2 | 19.0 |
| Stiffness = 300 MPa | −19.55 | −19.55 | −20.2 |
| Slope = 0.30 min | −16.63 | −17.41 | −17.3 |
| True Binder Grading | 81-27 | 77-27 | 76-27 |
| Performance Grade | 76-22 | 76-22 | 76-22 |

TABLE 4 shows that as the rosin oil content in the modified-bitumen samples increases, the upper temperature binder grading decreases. Nonetheless, the rosin oil-modified bitumen did not fail the 76-22 specification, even at the level of 3.0% rosin oil. Therefore, the treatment of polymer-modified bitumen with rosin oil did not have a materially undesirable effect on the Superpave performance grade of the bitumen.

While the disclosure has been described by reference to various specific embodiments, it should be understood that numerous changes may be made within the spirit and scope of the inventive concepts described. It is intended that the disclosure not be limited to the described embodiments, but will have full scope defined by the language of the following claims.

We claim:

1. A rosin oil-modified bitumen compound, comprising:
(a) bitumen component; and
(b) rosin oil, wherein an amount of the rosin oil is from about 0.01 to about 25 parts per 100 parts of the bitumen component in (a).

2. The compound of claim 1, characterized by a reduction in viscosity of up to 60% compared to a viscosity of the bitumen compound (a) at same temperature.

3. The compound of claim 1, characterized by a reduction in viscosity of up to 50% compared to a viscosity of the bitumen compound (a) at same temperature.

4. The compound of claim 1, wherein the bitumen component comprises a member selected from the group consisting of naturally occurring bitumen, bitumen derived from crude oil, petroleum pitch obtained from a cracking process, coal tar, and mixtures thereof.

5. The compound of claim 1, wherein the bitumen component comprises a member selected from the group consisting of polymer-modified bitumen, rubberized bitumen, acid-modified bitumen, wax-modified bitumen, and mixtures thereof.

6. The compound of claim 5, wherein the polymer-modified bitumen comprises a member selected from the group consisting of rubbers, plastomers, thermoplastic resins, and mixtures thereof.

7. The compound of claim 5, wherein the polymer-modified bitumen comprises a member selected from the group consisting of thermosetting resins, elastomers, and combinations thereof.

8. The compound of claim 5, wherein the polymer-modified bitumen comprises a member selected from the group consisting of styrene-butadiene-styrene rubbers, styrene-butadiene rubbers, butadiene-styrene rubbers, polyisoprene, polybutylene, vinyl polymers, ethylene-vinyl acetate polymers, and combinations thereof.

9. The compound of claim 1, wherein a source of the rosin oil includes a member selected from the group consisting of tall oil rosin, gum rosin, wood rosin, and mixtures thereof.

10. A bituminous composition, including:
(i) rosin oil-modified bitumen compound comprising:
(a) bitumen component, and
(b) rosin oil, wherein an amount of the rosin oil is from about 0.01 to about 25 parts per 100 parts of the bitumen component in (a); and
(ii) aggregate.

11. The composition of claim 10, wherein the rosin oil-modified bitumen is characterized by a reduction in viscosity of up to 60% compared to a viscosity of the bitumen compound (a) at same temperature.

12. The composition of claim 10, wherein the rosin oil-modified bitumen is characterized by a reduction in viscosity of up to 50% compared to a viscosity of the bitumen compound (a) at same temperature.

13. The composition of claim 10, characterized by a reduction in an indirect tensile of no more than 20% compared to an indirect tensile of a bituminous compound made of bitumen component (a) and same aggregate.

14. The composition of claim 13, further characterized by a reduction in viscosity of the rosin oil-modified bitumen of up to 60% compared to a viscosity of the bitumen compound (a) at same temperature.

15. The composition of claim 10, wherein the bitumen component comprises a member selected from the group consisting of naturally occurring bitumen, bitumen derived from crude oil, petroleum pitch obtained from a cracking process, coal tar, and mixtures thereof.

16. The composition of claim 10, wherein the bitumen component comprises a member selected from the group consisting of polymer-modified bitumen, rubberized bitumen, acid-modified bitumen, wax-modified bitumen, and mixtures thereof.

17. The composition of claim 16, wherein the polymer-modified bitumen comprises a member selected from the group consisting of rubbers, plastomers, thermoplastic resins, and mixtures thereof.

18. The composition of claim 16, wherein the polymer-modified bitumen comprises a member selected from the group consisting of thermosetting resins, elastomers, and combinations thereof.

19. The composition of claim 16, wherein the polymer-modified bitumen comprises a member selected from the group consisting of styrene-butadiene-styrene rubbers, styrene-butadiene rubbers, butadiene-styrene rubbers, polyisoprene, polybutylene, vinyl polymers, ethylene-vinyl acetate polymers, and combinations thereof.

20. The composition of claim 10, wherein a source of the rosin oil includes a member selected from the group consisting of tall oil rosin, gum rosin, wood rosin, and mixtures thereof.

21. The composition of claim 10, wherein the aggregate includes a member selected from the group consisting of dense-graded aggregate, gap-graded aggregate, open-graded aggregate, stone-matrix asphalt, reclaimed asphalt pavement, reclaimed roofing shingles and mixtures thereof.

22. The composition of claim 10, further comprising an additive selected from the group consisting of surfactants, mineral additives, fibrous additives, and combinations thereof.

23. A paved road, including the bituminous composition of claim 10.
